(19) United States
(12) Patent Application Publication
(10) Pub. No.: US 2025/0162229 A1
(43) Pub. Date: May 22, 2025

(54) METHOD FOR PRODUCING A VEHICLE INTERIOR COMPONENT

(71) Applicant: LEAR CORPORATION, Southfield, MI (US)

(72) Inventors: Haifeng LIU, Novi, MI (US); Michelle A. BRUDZYNSKY, Farmington Hills, MI (US); Ibrahim VALENZUELA, Novi, MI (US); Christopher D. JOHNSON, Novi, MI (US); Kevin Mitchell GEISLER, Menlo Park, CA (US); Joshua HALLOCK, Warren, MI (US)

(73) Assignee: LEAR CORPORATION, Southfield, MI (US)

(21) Appl. No.: 18/873,620

(22) PCT Filed: Jun. 27, 2023
(86) PCT No.: PCT/US2023/026354

§ 371 Date: Dec. 10, 2024

Related U.S. Application Data
(60) Provisional application No. 63/356,249, filed on Jun. 28, 2022.

(30) Foreign Application Priority Data
Jan. 19, 2023 (DK) PA202370026

(51) Int. Cl. B29C 48/15; B29C 48/05; B29C 48/345; B29C 48/88; B29L 31/30; B60N 2/70

(52) U.S. Cl. CPC B29C 48/15; B29C 48/05; B29C 48/345; B29C 48/919; B60N 2/7017; B29L 2031/3005

(57) ABSTRACT

A method for producing a vehicle interior component may include heating a polymeric material to a molten state to create a molten polymer. The molten polymer may be extruded to form a plurality of molten polymeric filaments. A fastening arrangement may be inserted into the molten polymer, and the molten polymer may be cooled in a fluid bath to create a consolidated filament structure having the fastening arrangement secured thereto.

### CROSS-REFERENCE TO RELATED APPLICATIONS

This application claims the benefit of Denmark patent application no. PA202370026, filed Jan. 19, 2023, which in turn claims the benefit of U.S. provisional application Ser. No. 63/356,249, filed Jun. 28, 2022, the disclosures of which are hereby incorporated in their entirety by reference herein.

### TECHNICAL FIELD

The present disclosure relates to a method and apparatus for producing a vehicle interior component.

### BRIEF DESCRIPTION OF THE DRAWINGS

FIG. 1 shows a schematic illustration of a system and method in accordance with embodiments described herein;

FIG. 2 shows a schematic illustration of an embodiment of a portion of the method shown in FIG. 1;

FIG. 3 shows a schematic illustration of a fastener arrangement that can be used with the method shown in FIG. 2;

FIG. 4 shows a schematic illustration of an embodiment of a portion of the method shown in FIG. 1;

FIG. 5 shows a secondary extrusion head that may be used as part of a system and method in accordance with embodiments described herein;

FIG. 6 shows a consolidated filament structure having a fastening arrangement secured thereto in accordance with embodiments described herein;

FIG. 7 shows a schematic illustration of an embodiment of a portion of the method shown in FIG. 1; and

FIGS. 8A-8C show a schematic illustration of steps that may be performed in the embodiment shown in FIG. 7.

### DETAILED DESCRIPTION

Reference will now be made in detail to embodiments, examples of which are illustrated in the accompanying drawings. In the following detailed description, numerous specific details are set forth to provide a thorough understanding of the various described embodiments. It will be apparent to one of ordinary skill in the art, however, that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale: some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element—e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and similarly a second contact could be termed a first contact, without departing from the scope of the various described embodiments. The first contact and the second contact are both contacts, but they are not the same contact.

The terminology used in the description of the various embodiments herein is for the purpose of describing particular embodiments only and is not intended to be limiting. As used in the description of the various embodiments and the appended claims, the singular forms “a”, “an” and “the” are intended to include the plural forms as well, unless the context clearly indicates otherwise. It will be further understood that the terms “includes,” “including,” “comprises,” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

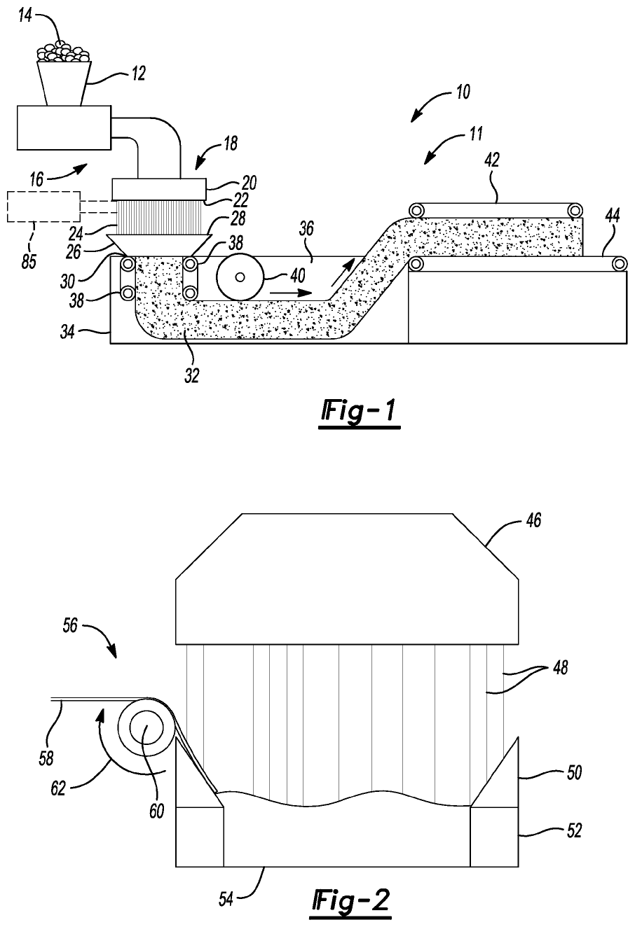

Referring to FIG. 1, a schematic illustration of a system 10 usable with a method 11 in accordance with embodiments described herein is shown. A hopper 12 holds solid granules of a polymeric material 14 that is to be extruded. In this embodiment, the material 14 is linear low-density polyethylene (LLDPE), although methods described herein may use different types of polymers as desirable and effective to produce the finished product. The material 14 is fed from the hopper 12 to an extruder 16. The extruder 16 melts and transports the material 14 to a die-plate arrangement 18, which includes a die plate 20. The extruder 16 may be, for example, a conventional extruder that includes a barrel that receives a rotatable screw. Rotation of the screw forces the material 14 to move through the barrel and helps heat the material because of the friction generated as the screw rotates. Heating elements may be disposed on the barrel and heat the polymeric material 14 inside the barrel.

The material 14 exits the extruder 16 at location 22 under pressure and in a molten state. Unless otherwise stated, the term “molten” as used herein means that the material is at least partially melted. It does not mean that the material is necessarily in a fully liquid state; rather, it means that the material is not completely solid and is still able to flow through elements of the system 10. For example, the molten material is still able to flow through the die plate 20, but it may be very viscous and starting to solidify. Once the solid granules of the polymeric material 14 are melted in the extruder 16, the material will begin to cool as it ceases to be agitated by the extruder screw and gets farther from any heaters. At different points in the process 11, the material may have a higher or lower viscosity, but if it is still partially melted and able to flow—even slowly—the term “molten” is applied herein.

The die plate 20 extrudes the material 14 into filaments 24. More specifically, the die plate 20 has multiple holes 21 disposed therethrough—see, e.g., FIG. 2—through which the molten material 14 passes. A single filament 24 is extruded from each die-plate hole. The filaments 24 fall downward from the die plate 20 under system pressure and the force of gravity to a funnel 26. The funnel 26 helps consolidate or group the filaments 24 into a more compact arrangement in which the filaments 24 bend or loop, and each filament 24 contacts and bonds to at least one other filament 24. In this embodiment, the funnel 26 has a funnel inlet 28 and a funnel outlet 30 that is smaller than the funnel inlet 28. More specifically, the funnel 26 is narrower at the funnel outlet 30 than at the funnel inlet 28. Individual separated filaments 24 enter the funnel inlet 28, the filaments 24 then bend or loop and move into contact with each other as they accumulate and slide down the funnel 26 toward the funnel outlet 30, and the consolidated filament structure 32 exits the funnel outlet 30 and enters a water tank 34. When the filaments 24 reach the funnel 26, those filaments near the outer part of the funnel 26—approximately 2-3 rows—slide down an angled surface of the funnel 26, which creates a skin on the consolidated filament structure 32.

The water tank 34 holds water 36 and receives the consolidated filament structure 32 from the funnel 26. The water 36 performs at least two functions. First, it helps to temporarily support the consolidated filament structure 32 to prevent it from collapsing or condensing into a less open or less porous arrangement. As such, the water 36 provides some resistance that causes the additional bending and looping of the filaments 24 to further build the consolidated filament structure 32. Second, the water 36 cools the polymeric filaments 24 from the outside to solidify them. The temperature of the water 36 may be much less than the temperature of the filaments 24 as they leave the die plate 20, for example, it may be at the temperature of the ambient environment surrounding the tank 34. Although the fluid used in this embodiment is liquid water 36, in other embodiments, other types of fluids may be used.

The water tank 34 includes various rollers and conveyors that help move the consolidated filament structure 32 through and out of the water 36. A tractor conveyor 38 is submerged in the water 36 and engages opposing lateral sides of the consolidated filament structure 32 to move it away from the funnel 26 at approximately the same speed as the consolidated filament structure 32 exits the funnel 26. The gap between the opposing portions of the tractor conveyor 38 is slightly narrower than the width of the consolidated filament structure 32 to allow the tractor conveyor 38 to better grip the consolidated filament structure 32. As previously noted, FIG. 1 is a schematic representation and has been simplified for illustration purposes. For example, a conveyor, such as the tractor conveyor 38, may be located toward the front and back of the system 10 as it is oriented in FIG. 1, rather on the left and right sides as shown.

Another roller 40 helps keep the consolidated filament structure 32 submerged and helps guide it through the water 36 toward a conveyor belt 42 and a shaker table 44 that are positioned outside of the water tank 34. The shaker table 44 shakes the consolidated filament structure 32 while it is on the conveyor belt 42 to remove at least some of the water 36. Pressurized air may also be blown toward the consolidated filament structure 32, which may also be squeezed to remove more of the water 36. Finally, the consolidated filament structure 32 may be cut to a desired size and shape. As described above, the consolidated filament structure 32 forms a stranded-mesh material that may be used, for example, as a cushion blank for part of a vehicle interior component. In some cases, the consolidated filament structure 32 may have a rectangular cross section that is later cut or shaped to a desired contour for its intended use.

FIG. 2 shows a portion of a system, such as the system 10, performing an embodiment of a method described herein. More specifically, FIG. 2 shows a die plate 46 having a plurality of holes disposed therethrough, which is used to extrude a molten polymer into a plurality of molten polymeric filaments 48, only some of which are labeled in FIG. 2 for clarity. Similar to the process illustrated in FIG. 1, the molten polymeric filaments 48 fall downward from the die plate 46 toward a funnel arrangement 50. Once having traversed the funnel arrangement 50, the molten polymeric filaments 48 enter a fluid tank 52, where they are introduced into a fluid bath. In this embodiment, the fluid tank 52 contains water 54. As described above in conjunction with FIG. 1, the fluid bath is for, among other things, cooling the molten polymer. FIG. 2 also shows the step of introducing a fastening arrangement 56 into the molten polymer. In this step, the fastening arrangement 56 is inserted into or combined with the molten polymer. In this embodiment, the fastening arrangement 56 is introduced into the molten polymer after the molten polymeric filaments 48 are formed. As explained in more detail below, in other embodiments, a fastening arrangement, such as the fastening arrangement 56, may be introduced into the molten polymer as it is extruded through a die plate—i.e., through the same die plate where the molten polymeric filaments 48 are formed.

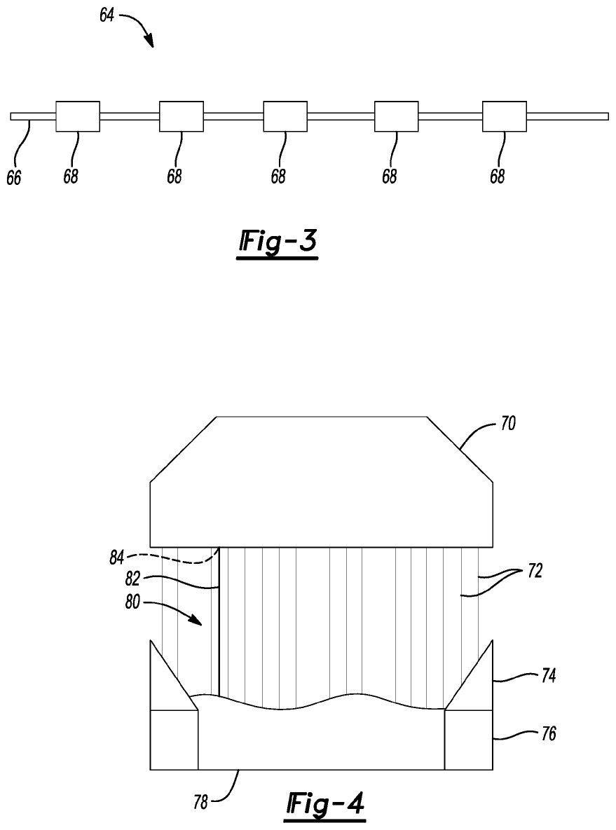

As shown in FIG. 2, the fastening arrangement 56 comprises a strand portion 58, which is configured as an elongated member. The fastening arrangement 56 may comprise a plastic bead, a cloth material, for example, duon, or it may be a string, rope, or other similar structure. When this type of fastening arrangement is used, it may provide, for example, a fixation for rings, clips, etc. attached to a trim cover or other material that is to be positioned over the resulting product, such as a consolidated filament structure. As explained in more detail in conjunction with FIG. 3, the fastening arrangement 56 may comprise a plurality of discrete fasteners. The strand portion 58 may have a defined length, and in particular, a defined length that is long enough to accommodate the length of a resulting product, such as the consolidated filament structure 32 shown in FIG. 1. In the embodiment shown in FIG. 2, the fastening arrangement 56, and more particularly, the strand portion 58, is continuously inserted into the molten polymer over at least a portion of its defined length. In this embodiment, it is continuously inserted from a spool 60, which rotates as indicated by the directional arrow 62.

As described above, a fastening arrangement, such as the fastening arrangement 56, may comprise a plurality of discrete fasteners such as schematically illustrated in FIG. 3. In the embodiment illustrated in FIG. 3, a fastening arrangement 64 includes a strand portion 66, which forms an elongated member of the fastening arrangement 64. The fastening arrangement 64 shown in FIG. 3 is a segment of what may be a much longer structure. In addition to the strand portion 66, the fastening arrangement 64 also includes a plurality of discrete fasteners 68, which may be, for example, Christmas tree fasteners, clips, pushpins, etc. Because the fasteners 68 are attached to the strand portion 66, which is continuously fed into the molten polymer, the fasteners 68 are introduced and inserted into the molten polymer at a predetermined frequency that is defined by the distance between the fasteners 68 and the rate of the insertion of the fastening arrangement 64 into the molten polymer.

The fasteners 68 are also introduced and inserted into the molten polymer at predetermined locations, which again, may be defined by the distance between the fasteners 68 and the rate the fastening arrangement 64 is introduced into the molten polymer. The location of the fasteners 68 relative to the molten polymeric filaments 48 may also be determined by where the fasteners 68 are positioned when they are inserted into the molten polymer. For example, in the embodiment illustrated in FIG. 2, the fastening arrangement 56 is inserted very close to one edge of the molten polymeric filaments 48. This may yield a finished product having the fastening arrangement 56 very close to one surface, which makes it easily accessible for attachment to other products.

FIG. 4 also shows a portion of a system, such as the system 10, performing an embodiment of a method described herein. More specifically, FIG. 4 shows a die plate 70, having a plurality of holes disposed therethrough, which is used to extrude a molten polymer into a plurality of molten polymeric filaments 72, only some of which are labeled in FIG. 4 for clarity. Similar to the process illustrated in FIG. 1, the molten polymeric filaments 72 fall downward from the die plate 70 and are received by a funnel arrangement 74. Once having been introduced into the funnel arrangement 74 and having traversed the funnel arrangement 74, the molten polymeric filaments 72 enter a fluid tank 76, which in this embodiment contains water 78. A fastening arrangement 80 includes a strand portion 82, which may be similar to the strand portion 58 shown in FIG. 2, and the strand portion 66 shown in FIG. 3. In the embodiment shown in FIG. 4, the fastening arrangement 80 is introduced into the molten polymer through a larger hole 84 in the die plate 70, which may be referred to as a “co-extrusion” technique. The strand portion 82 may be continuously fed through the hole 84 as the molten polymer is extruded into the molten polymeric filaments 72.

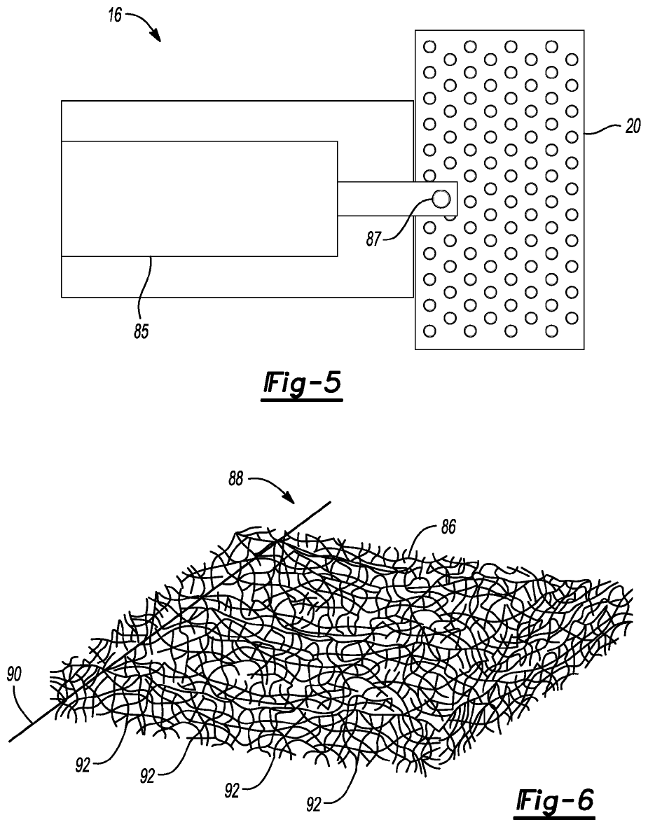

FIG. 1 shows a secondary extrusion head 85 in phantom through which the fastening arrangement 80 can be introduced under the die plate 20. A bottom view of the secondary extrusion head 85 is shown in FIG. 5, juxtaposed against the die plate 20. As shown in FIG. 5, a fastening arrangement, such as the fastening arrangement 80, may be introduced through the secondary extrusion head 85, and in particular, through an aperture 87.

In applications where the fastening arrangement does not include discrete fasteners—such as the fasteners 68 shown in FIG. 3—the strand portion 82 may be inserted through one of the standard holes in the die plate 70. Alternatively, a dedicated inlet tube could be inserted through the die plate 70 to accommodate a fastening arrangement having discrete fasteners that are larger than the standard die-plate holes. FIG. 6 shows a portion of a consolidated filament structure 86 having a fastening arrangement 88 attached thereto. The fastening arrangement 88 includes a strand portion 90 that is attached to the consolidated filament structure 86. More specifically, the fastening arrangement 88 is secured to the filaments 92—only some of which are labeled in FIG. 6 for clarity—by having been placed in contact with them while they were still in a molten state, so that when the filaments 92 cool, a secure bond is formed.

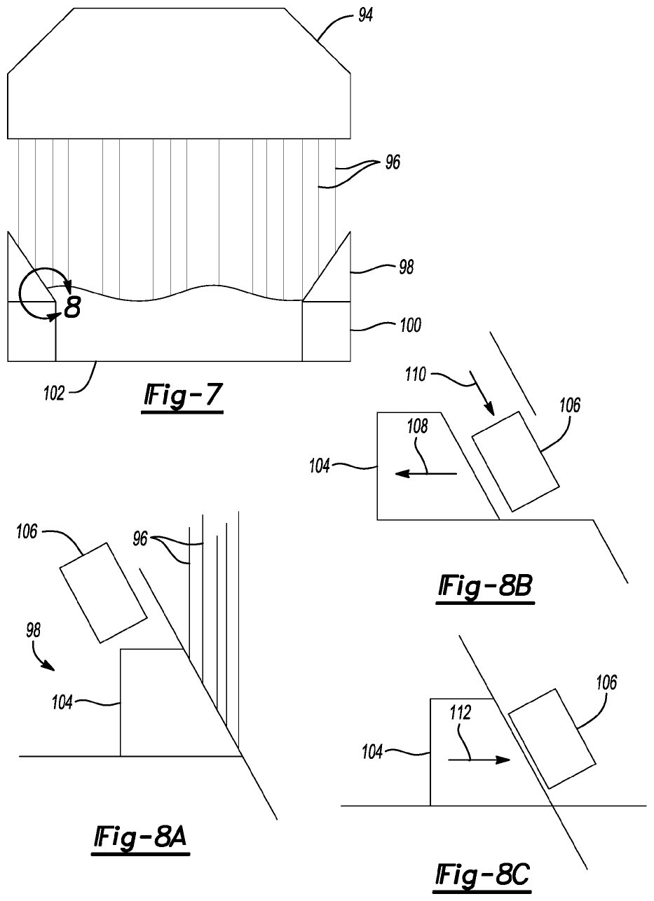

In FIG. 7, a portion of a system, such as the system 10, is illustrated. More specifically, FIG. 7 shows a die plate 94, having a plurality of holes disposed therethrough, which is used to extrude a molten polymer into a plurality of molten polymeric filaments 96. For clarity, only some of the polymeric filaments 96 are labeled in FIG. 7. The molten polymeric filaments 96 fall downward from the die plate 94 where they are introduced to a funnel arrangement 98. After leaving the funnel arrangement 98, the polymeric filaments 96 enter a fluid tank 100, which in this embodiment contains water 102. In the embodiment shown in FIG. 7, a fastening arrangement may be introduced to the molten polymeric filaments 96 through the funnel arrangement 98. The isolated detail 7 in FIG. 7 is shown enlarged in FIG. 8A. A schematic illustration of the process of inserting a fastening arrangement into the molten polymeric filaments 96 through the funnel arrangement 98 is shown in FIGS. 8B and 8C.

In FIG. 8A, a portion 104 of the funnel arrangement 98 is illustrated. As shown in FIG. 8A, the portion 104 of the funnel arrangement 98 is blocking a fastening arrangement 106 from being introduced into the molten polymeric filaments 96. In the embodiment shown in FIGS. 6 and 7, the portion 104 of the funnel arrangement 98 is movable to allow the fastening arrangement 106 to be combined with the molten polymeric filaments 96. This is illustrated in FIG. 8B, where the portion 104 of the funnel arrangement 98 has been moved to the left as indicated by the directional arrow 108. This allows the fastening arrangement 106 to move downward as illustrated by the directional arrow 110. In FIGS. 8B and 8C, the molten polymeric filaments 96 have been removed for clarity. Once the fastening arrangement 106 is introduced into the molten polymeric filaments 96, the portion 104 of the funnel arrangement 98 is moved back to its original position as indicated by the directional arrow 112. This embodiment allows discrete fasteners to be individually placed into contact with the molten polymeric filaments 96 at a predetermined frequency and at predetermined locations.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A method for producing a vehicle interior component, comprising:
heating a polymeric material to a molten state, such that it becomes a molten polymer;
introducing the molten polymer into a die plate having a plurality of holes disposed therethrough such that the molten polymer moves through the holes and forms a plurality of molten polymeric filaments;
introducing a fastening arrangement into the molten polymer; and
cooling the molten polymer after it leaves the die plate such that a consolidated filament structure is formed and the fastening arrangement is secured to the consolidated filament structure.

2. The method of claim 1, wherein the fastening arrangement is introduced into the molten polymer after the molten polymer is introduced into the die plate.

3. The method of claim 1, wherein the fastening arrangement is introduced into the molten polymer through the die plate.

4. The method of claim 1, wherein the fastening arrangement comprises a strand portion having a length, and the strand portion is continuously introduced into the molten polymer over at least a portion of the length.

5. The method of claim 1, wherein the fastening arrangement comprises a plurality of discrete fasteners, and the fasteners are introduced into the molten polymer at a predetermined frequency.

6. The method of claim 1, wherein cooling the molten polymer includes introducing the molten polymer into a fluid bath, the method further comprising receiving the molten polymer with a funnel arrangement before the molten polymer is introduced into the fluid bath, and wherein the fastening arrangement comprises a plurality of discrete fasteners, and the fasteners are introduced into the molten polymer through the funnel arrangement.

7. A vehicle interior component comprising a consolidated polymeric filament structure and a fastening arrangement bonded to the consolidated polymeric filament structure, wherein the fastening arrangement comprises a strand portion and a plurality of discrete fasteners attached to the strand portion.

8. A method for producing a vehicle interior component, comprising:
heating a polymeric material to a molten state to create a molten polymer;
extruding the molten polymer to form a plurality of molten polymeric filaments;
inserting a fastening arrangement into the molten polymer; and
cooling the molten polymer in a fluid bath to create a consolidated filament structure having the fastening arrangement secured thereto.

9. The method of claim 8, wherein the fastening arrangement includes an elongated member, and inserting the fastening arrangement into the molten polymer comprises continuously feeding the elongated member into the molten polymer for at least a portion of a length of the elongated member.

10. The method of claim 8, wherein the elongated member includes a plurality of discrete fasteners.

11. The method of claim 8, wherein the fastening arrangement comprises a plurality of discrete fasteners, and the fasteners are inserted into the molten polymer at predetermined locations in the molten polymer.

12. The method of claim 11, further comprising introducing the molten polymer into a funnel arrangement prior to cooling the molten polymer in the fluid bath, and wherein the fasteners are inserted into the molten polymer through the funnel arrangement.

13. The method of claim 8, wherein the fastening arrangement is inserted into the molten polymer after the molten polymer is extruded to form the molten polymeric filaments.

14. The method of claim 8, wherein the fastening arrangement is inserted into the molten polymer as the molten polymer is extruded to form the molten polymeric filaments.

15. The method of claim 8, wherein extruding the molten polymer includes introducing the molten polymer into an extruder and inserting the fastening arrangement into the molten polymer includes inserting the fastening arrangement through a different extruder.

16. A cushion blank for a vehicle interior component, the cushion blank comprising a consolidated polymeric filament structure and a fastening arrangement bonded to the consolidated polymeric filament structure, wherein the fastening arrangement comprises a strand portion and a plurality of discrete fasteners attached to the strand portion.

17. A method for producing a vehicle interior component, comprising:
heating a polymeric material to create a molten polymer;
forming a plurality of molten polymeric filaments from the molten polymer;
combining a fastening arrangement with the molten polymer; and
cooling the molten polymer in a fluid bath to create a consolidated filament structure having the fastening arrangement secured thereto.

18. The method of claim 17, wherein the fastening arrangement is combined with the molten polymer after the molten polymeric filaments are formed.

19. The method of claim 17, wherein the fastening arrangement is combined with the molten polymer as the molten polymeric filaments are formed.

20. The method of claim 17, wherein the fastening arrangement includes an elongated member, and combining the fastening arrangement with the molten polymer comprises continuously feeding the elongated member into the molten polymer for at least a portion of a length of the elongated member.
